(19) United States
(12) Patent Application Publication
(10) Pub. No.: US 2012/0027062 A1
(43) Pub. Date: Feb. 2, 2012

(54) APPARATUSES AND METHODS FOR SETTING AN ADAPTIVE FREQUENCY BAND FOR POWER LINE COMMUNCIATION

(75) Inventor: Humberto E. Garcia, Idaho Falls, ID (US)

(73) Assignee: BATTELLE ENERGY ALLIANCE, LLC, Idaho Falls, ID (US)

(21) Appl. No.: 12/845,467

(22) Filed: Jul. 28, 2010

(51) Int. Cl. H04B 3/54; H04B 17/00

(52) U.S. Cl. 375/224; 375/257

(57) ABSTRACT

Apparatuses and methods relating to power line communication are disclosed, and in particular, to an adaptive frequency band for power line communication. A power line communication device is disclosed. The power line communication device comprises a cutoff frequency estimator configured for estimating a cutoff frequency for communication in a power line communication network, and a processor operably coupled with the cutoff frequency estimator. The processor is configured to adaptively select boundaries of a frequency band in response to the estimated cutoff frequency. Other apparatuses and methods are disclosed.

### GOVERNMENT RIGHTS

This invention was made with government support under Contract Number DE-AC07-051D14517 awarded by the United States Department of Energy. The government has certain rights in the invention.

### TECHNICAL FIELD

Embodiments of the present invention relate generally to power line communication and, more specifically, to apparatuses and methods for setting an adaptive frequency band for power line communication (PLC) responsive to an on-line assessment of the PLC network.

### BACKGROUND

Power line communication involves data transmission over power lines, and may also be referred to as broadband over power line (BPL) communication. In particular, PLC devices (e.g., PLC modems) may transmit communications signals into an electrical power distribution system. A plurality of PLC devices coupled with an electrical power distribution system may be called a PLC network. Therefore, PLC devices may be employed in networking computer systems together in a manner similar to traditional networking systems, such as wireless and fiber-optic alternatives. PLC may have an advantage over these other networking systems in that communication signals may be transmitted over existing electrical wires, thus minimizing the cost and time in building additional infrastructure. PLC devices may also interface a PLC network with other networking systems.

Although PLC is anticipated to be a significant networking technology, many existing power lines were not specifically designed for data transmission. Therefore, the amplitude and phase response of a signal over a power line may vary significantly with frequency. Furthermore, signal reflection, signal attenuation, and transmission losses often occur due to the various impedance mismatches in a PLC network. Noise in the power line may also be a significant problem, which noise may also be frequency selective.

FIG. 1 is a schematic of a conventional PLC network 100. PLC network 100 may include a PLC device 110 coupled with power lines 120 to support interface with other networks, such as the Internet 130. The PLC device 110 may be coupled to the Internet 130 through connections 135 known in the art, such as fiber optic lines, T1 lines, wireless connections, etc. Power lines 120 may be medium voltage (MV) power lines carrying power signals that are stepped down by a transformer 140 for use by an end user (e.g., a home 150). The transformer 140 converts the medium voltage of power lines 120 to a low voltage (LV) of power lines 145 entering a home 150. Because most communication data (e.g., video data) requires a high throughput, high frequencies (e.g., 20 MHz) for data transmission may also be desired; however, the transformer 140 may also act as a low pass filter to filter out high frequency signals and pass the low frequency power signal (e.g., 60 Hz in USA). For example, many transformers 140 are configured to filter out signals above 5 kHz and pass signals below 5 kHz. In order for the high frequency data signals to be passed, additional infrastructure, such as a PLC extraction device 142, may be required to be associated with a transformer 140 in order for data signals to bypass the transformer 140. A PLC extraction device 142 may also be called a jumper. The PLC extraction device 142 may be configured as a high pass filter or a notch filter that passes high frequency (e.g., 20 MHz) data signals while filtering out low frequencies (e.g., 60 Hz power signal). As a result, the combination of the power signal (e.g., 60 Hz) and the data signal (e.g., 20 MHz) may enter the home 150 through power lines 145. In order to interpret the data signals, the home 150 may be equipped with a PLC modem configured to demodulate incoming data signals and modulate outgoing data signals according to the carrier frequencies of the data signals.

Other PLC devices may be included within PLC network 100 that are not shown in FIG. 1, which other PLC devices may include those that may exist within the home 150 to support communication among devices (e.g., personal computers, printers, smart appliances) connected within the household power network and coupled via in-house PLC devices. As previously mentioned, each device (e.g., personal computers, printers, and smart appliances) providing inter communication within the home 150 may be operably coupled with an in-house PLC modem.

In a conventional PLC network 100, PLC devices 110 transmit the data signal into the household power network and the power line 120 within a fixed frequency band. The fixed frequency band is generally based on the desired data rate for the information to be transmitted. PLC has generally targeted home and small business markets due to cost savings and the clean electrical environment to maintain connectivity; however, in atypical environments, such as industrial or large business use, limitations in the PLC may exist partly due to fluctuations that large equipment and heavy machinery contribute to the electrical environment, and also due to the electrical infrastructure itself (e.g., PLC extraction devices and transformers).

For example, FIGS. 2A and 2B are schematic illustrations of frequency responses 200, 250 for a conventional PLC network, including fixed frequency bands 220, 270 for communication between conventional PLC devices. A frequency response 200, 250 shows a system's gain of an output signal 210, 260 in response to an input signal for each frequency of a spectrum. The x-axis represents the frequency of the signal, and the y-axis represents the gain of the output signal 210, 260 in response to the input signal for a given frequency. If the frequency response 200, 250 for a transmitted signal with a given frequency exhibits a gain for the output signal 210, 260 below a certain threshold 205, 255, the transmitted signal may be overly attenuated resulting in unreliable transmission, or the signal may not be able to be transmitted at all.

In FIG. 2A, region 230 shows an example of a range of frequencies in which the frequency response 200 is unacceptable for reliable communication. Conventional PLC devices may be configured for communication within a fixed frequency band 220 at certain carrier frequencies. Carrier frequencies are indicated in FIGS. 2A and 2B by lines (f₁, f₂, . . . fₙ). Conventional PLC devices may adaptively select carrier frequencies within the fixed frequency band 220 to the extent that carrier frequencies (e.g., within region 230) with a frequency response 200 below the threshold 205 for an acceptable gain are deactivated. For example, by using spread spectrum modulation, a conventional PLC device can deactivate unreliable frequency carriers within the fixed frequency band 220 with unacceptable resonances and narrow band noises, while maintaining acceptable data and error rates.

In conventional PLC devices, however, the boundaries of the frequency band 220 itself are fixed—generally to accommodate a desired data transmission rate. Even though the range of the fixed frequency band 220 is often selected to be large enough in order to accommodate many typical PLC networks, there exist PLC networks in which most, if not all, frequency carriers within the fixed frequency band 220 may be unusable for communication. As a result, conventional PLC devices may be nonoperational for such PLC networks.

FIG. 2B illustrates a frequency response 250 for a PLC network in which a conventional PLC device communicates over a fixed frequency band 270. The frequency response shows that all carrier frequencies above a cutoff frequency (f_{c}) may result in a gain that is below the threshold 255, which gain may result in an unreliable output signal 260. As conventional PLC devices communicate over a fixed frequency band 270, if the characteristics of the PLC network change such that most or all of the carrier frequencies within the fixed frequency band 270 fall below the threshold 255, the PLC device may be incapable of communicating reliably over the frequencies for which the PLC device was designed. This communication incapability may be temporary or even permanent depending on the cause and duration of the changing characteristics of the PLC network.

As an example, a machine (e.g., motor) may add noise to the PLC network at certain frequencies. Additionally, components such as line conditioners or transformers may be added to the PLC network that act as low pass filters and filter out communication signals. In order to avoid such a situation, PLC extraction devices (FIG. 1) may be added to the infrastructure of the PLC network to bypass the components (e.g., power line conditioners, transformers, etc.) that act as filters to the communication signals. For residential PLC networks, the frequency responses may be fairly uniform and predictable such that designing a PLC device with a fixed frequency band and adding PLC extraction devices may not be overly complex. For industrial settings where large motors and other machinery may introduce noise and a large number of filters into the PLC network, however, designing a PLC network with a fixed frequency band with PLC extraction devices associated with the machinery may be complex, expensive, or not even operate in a desirable manner.

### BRIEF SUMMARY

An embodiment of the present invention includes a power line communication device. The power line communication device includes a cutoff frequency estimator configured for estimating a cutoff frequency for communication in a power line communication network, and a processor operably coupled with the cutoff frequency estimator, wherein the processor is configured to adaptively select boundaries of a frequency band in response to the estimated cutoff frequency.

Another embodiment of the present invention includes a power line communication device. The power line communication device includes a transmitter configured for transmitting communication signals on a power line communication network at frequencies within an adaptive frequency band, a receiver configured for receiving communication signals from the power line communication network at frequencies within the adaptive frequency band, and a processor operably coupled with the transmitter and the receiver. The processor is configured to dynamically select an upper boundary of the adaptive frequency band independently from a lower boundary of the adaptive frequency band.

Yet another embodiment of the present invention includes a method for dynamically adjusting a frequency band for communicating over a power line communication network. The method includes estimating a cutoff frequency for a power line communication network, and adjusting an upper boundary of an adaptive frequency band for communicating over the power line communication network responsive to estimating the cutoff frequency.

### BRIEF DESCRIPTION OF THE DRAWINGS

FIG. 1 is a schematic of a conventional PLC network.

FIGS. 2A and 2B are schematic representations of frequency responses for a conventional PLC network, including fixed frequency bands for communication between conventional PLC devices.

FIGS. 3A and 3B are schematic representations of frequency responses for a PLC network, including adaptive frequency bands for communication between PLC devices according to an embodiment of the present invention.

FIG. 4A is a schematic block diagram of a portion of a PLC device according to an embodiment of the present invention.

FIG. 4B is a flow chart illustrating a method for communicating over a PLC network with a PLC device including dynamically adjusting an adaptable frequency band according to an embodiment of the present invention.

FIG. 5A is a schematic block diagram of a PLC device according to an embodiment of the present invention.

FIGS. 5B and 5C are flow diagrams illustrating methods for estimating the impedance of a PLC network used to estimate a cutoff frequency for communication over a PLC network according to an embodiment of the present invention.

FIG. 6A is a schematic block diagram of a PLC network according to an embodiment of the present invention.

FIG. 6B is a flow chart illustrating a method for determining a cutoff frequency according to an embodiment of the present invention.

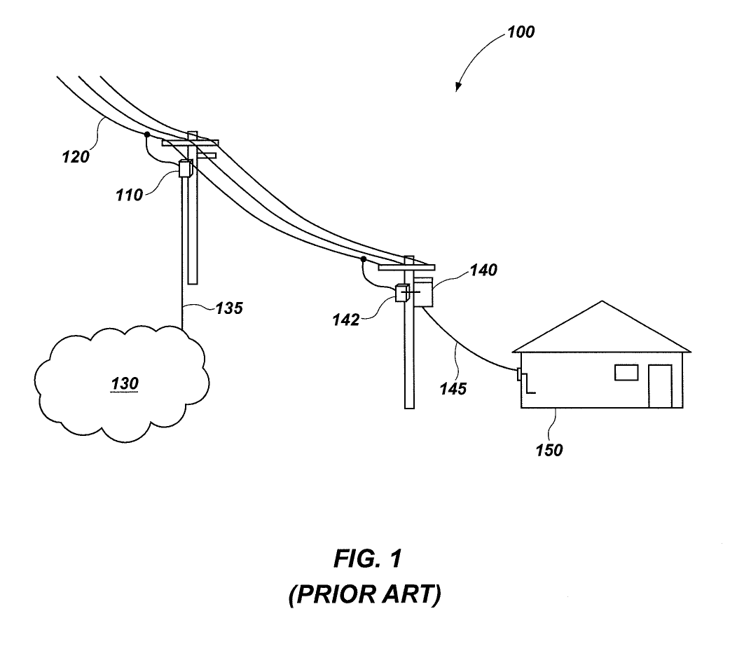

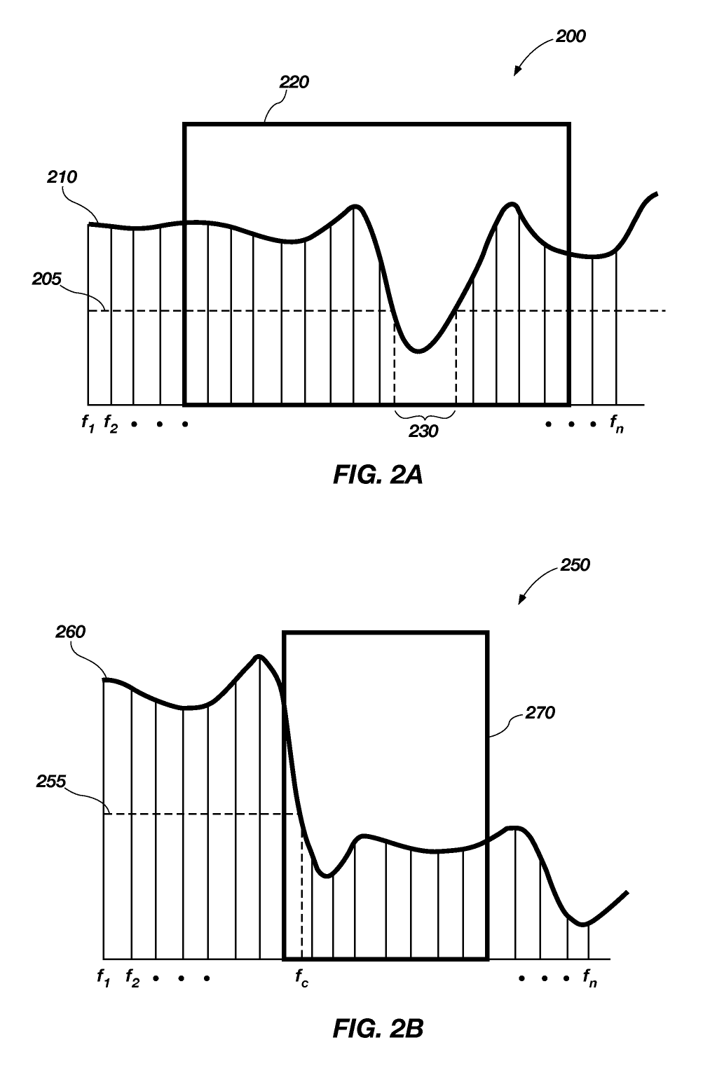

### DETAILED DESCRIPTION

In the following detailed description, reference is made to the accompanying drawings which form a part hereof and, in which is shown by way of illustration, specific embodiments in which the invention may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, specific implementations shown and described are only examples and should not be construed as the only way to implement the present invention unless specified otherwise herein. It will be readily apparent to one of ordinary skill in the art that the various embodiments of the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

Referring in general to the following description and accompanying drawings, various embodiments of the present invention are illustrated to show its structure and method of operation. Common elements of the illustrated embodiments may be designated with like reference numerals. It should be understood that the figures presented are not meant to be illustrative of actual views of any particular portion of the actual structure or method, but are merely idealized representations employed to more clearly and fully depict the present invention defined by the claims below.

It should be appreciated and understood that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

It should be further appreciated and understood that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and steps are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the invention described herein.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

The term “cutoff frequency” as used herein denotes a boundary in a PLC network's frequency response at which the energy entering the power line is attenuated, reflected, or grounded, instead of transmitted. The term “cutoff frequency” is also used herein to denote the frequency boundary, beyond which communication may not be sufficiently reliable or possible as transmitted, whereupon the power loss drops below a predetermined threshold. The cutoff frequency may be based, at least in part, on the equivalent insertion loss curve of the PLC network.

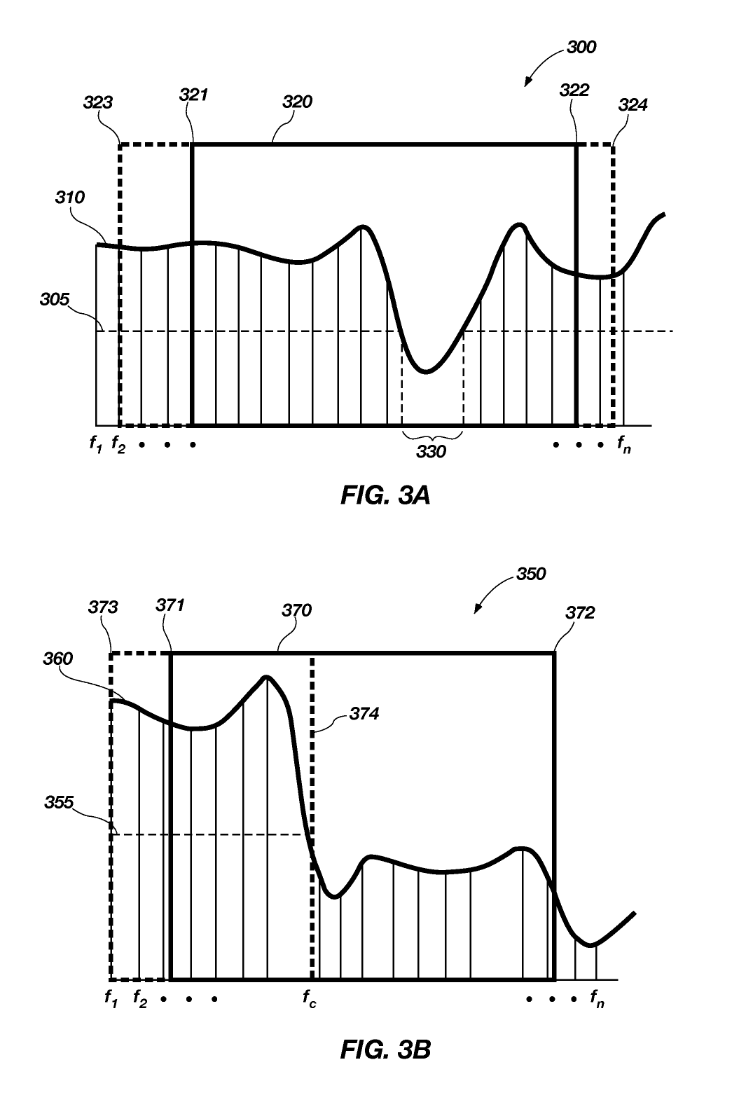

FIGS. 3A and 3B are schematic representations of frequency responses 300, 350 for a PLC network, including adaptive frequency bands 320, 370 for communication between PLC devices according to an embodiment of the present invention. A frequency response 300, 350 is a system's gain of an output signal 310, 360 in response to an input signal for each frequency of a spectrum. The x-axis represents the frequency of the signal, and the y-axis represents the gain of the output signal 310, 360 in response to the input signal for a given frequency. If the frequency response 300, 350 for a transmitted signal with a given frequency exhibits a gain for an output signal 310, 360 that is below a certain threshold 305, 355, the transmitted signal may be overly attenuated resulting in unreliable transmission, or the transmitted signal may not be able to be transmitted at all (e.g., reflected, grounded, etc.).

In FIG. 3A, region 330 shows an example of a range of frequencies in which the frequency response 300 is unacceptable for reliable communication. PLC devices may be configured for communication at certain carrier frequencies within an adaptive frequency band 320. Carrier frequencies are indicated in FIGS. 3A and 3B by lines (f₁, f₂, . . . fₙ). PLC devices may be further configured to adaptively select carrier frequencies within the adaptive frequency band 320 to the extent that carrier frequencies (e.g., within region 330) with a frequency response 300 below the threshold 305 for an acceptable gain are deactivated. For example, by employing spread spectrum modulation techniques, a PLC device can deactivate unreliable frequency carriers (e.g., within region 330) within the adaptive frequency band 320 with unacceptable resonances and narrow band noises, while maintaining acceptable data and error rates. Even though the initial range of an adaptive frequency band 320 may be selected to be large enough in order to accommodate many typical PLC networks, there may exist PLC networks in which most, if not all, frequency carriers within the initial range of the adaptive frequency band 320 may be unusable for communication. While conventional PLC devices may be nonoperational for such atypical PLC networks for fluctuations in the PLC network, PLC devices with an adaptive frequency band 320 may dynamically adjust the boundaries of the adaptive frequency band responsive to on-line assessment of the power line.

For example, the adaptive frequency band 320 may have an enlarged range such that an initial lower boundary 321 and an initial upper boundary 322 are altered to have a new lower boundary 323 and a new upper boundary 324. Enlarging the range of the adaptive frequency band 320 is shown as a non-limiting example, and each boundary may be independently moved to a higher frequency or a lower frequency, as the case may be. The frequency for the new upper boundary 324 of the adaptive frequency band 320 may be responsive to a determination of the cutoff frequency of the PLC network. As a result, the new upper boundary 324 may be ensured to be at or below the cutoff frequency of the PLC network. The new lower boundary 323 of the adaptive frequency band 320 may be based, at least in part, on maintaining carrier frequencies for the carrier signals in order to achieve a desired throughput, or based, at least in part, on having a range of carrier frequencies to ensure a desired probability for reliable carrier signals below the cutoff frequency (f_{c}), or both. The frequency for the new lower boundary 323 may also be based on other factors.

FIG. 3B is a frequency response 350 for a PLC network in which a PLC device communicates over an adaptive frequency band 370 according to an embodiment of the present invention. The frequency response 350 shows that carrier frequencies above a cutoff frequency (f_{c}) may exhibit a gain that is below the threshold 355, which gain may result in an unreliable output signal 360. For example, unexpected fluctuations (e.g., caused by a motor) in the PLC network may cause noise or other filtering effects to alter the signal characteristics for some of the carrier frequencies within the adaptive frequency band 370.

As conventional PLC devices communicate over a fixed frequency band, if most or all of the carrier frequencies within the fixed frequency band fall below the threshold, the PLC device may be incapable of communicating reliably over the frequencies for which the PLC device was initially designed; however, the boundaries of the adaptive frequency band 370 may be adjusted responsive to an on-line assessment of the PLC network during operation thereof. For example, the initial lower boundary 371 and the initial upper boundary 372 of the adaptive frequency band 370 may be adjusted to a new lower boundary 373 and a new upper boundary 374, respectively. The on-line assessment may include estimating a cutoff frequency (f_{c}) for the PLC network, and adjusting the boundaries of the adaptive frequency band 370 in response to the estimated cutoff frequency (f_{c}). As a result, the new upper boundary 374 may be ensured to be approximately at or below the cutoff frequency (f_{c}) of the PLC network. The new lower boundary 373 of the adaptive frequency band 370 may be based, at least in part, on maintaining frequencies to achieve a desired throughput, or based, at least in part, on having a range of carrier frequencies to ensure a desired probability for reliable carrier signals below the cutoff frequency (f_{c}), or both. The frequency for the new lower boundary 373 may also be based on other factors. The new range of the adaptive frequency band 370 may include carrier frequencies (e.g., f₁, f₂ . . . f_{c}) that exhibit a gain for an output signal 360 above threshold 355, which frequencies may provide reliable communication.

It should be noted that references to a “new” upper or lower boundary refer to situations in which the adaptive frequency band 370 may be changed. There may be situations in which changing the one or more of the boundaries of the adaptive frequency band 370 may not be desirable. For example, the results of an on-line assessment of the PLC network may estimate that the cutoff frequency is sufficiently above the initial upper boundary 372. In such a situation, it may be desirable to maintain the status quo for the adaptive frequency band 370. In other situations, as the boundaries of the adaptive frequency band 370 may be independently changed, it may be desirable to change the frequency for only one of the boundaries of the adaptive frequency band 370.

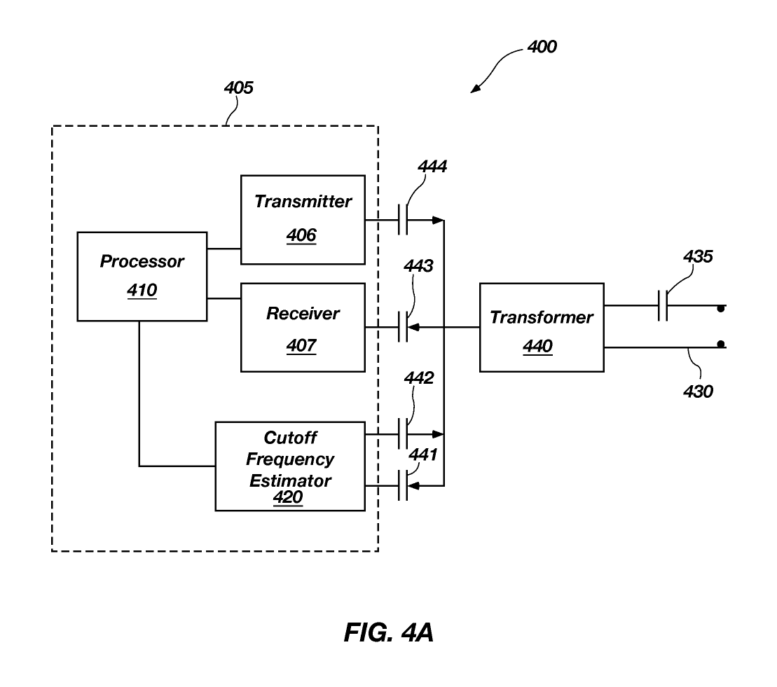

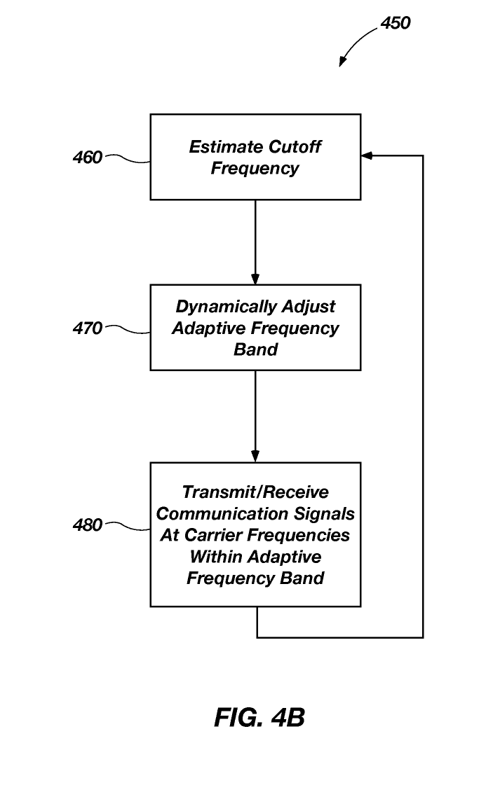

FIG. 4A is a schematic block diagram of a portion of a PLC device 400 according to an embodiment of the present invention. PLC device 400 includes a PLC internal module 405 operably coupled with a power line (not shown) through power connectors 430 for data transmission with other PLC devices (not shown) in the PLC network. The PLC internal module 405 includes a processor 410 operably coupled with a cutoff frequency estimator 420 configured for determining the boundaries for an adaptive frequency band for communication over a power line of the PLC network. Processor 410 may include one or more processors for performing functions described herein. The PLC internal module 405 further includes a transmitter 406 and a receiver 407 operably coupled to the processor 410. The PLC internal module 405 may be operably coupled to the power line through the power connectors 430, with the cutoff frequency estimator 420, transmitter 406, and receiver 407 being coupled with the power line through coupling circuits 441-444. The PLC device 400 may be coupled with the power line through a transformer 440 (i.e., coupling transformer) and a high voltage capacitor 435. The high voltage capacitor 435 may be coupled with the power connectors 430 that couple with the power line. While the high voltage capacitor 435 may be configured to allow data carriers to pass, the coupling transformer may be configured for isolating and protecting the internal electronics of the PLC device 400 from the high voltage power line.

The transmitter 406 and receiver 407 may be configured for respectively transmitting and receiving communication signals to be carried by the power line. While the transmitter 406 and receiver 407 are shown as two discrete blocks, a transmitter 406 and receiver 407 may be combined in a single component performing such functions, such as a transceiver. The transmitter 406 and receiver 407 may be configured for modulating and demodulating information with carrier signals according to techniques and methods known in the art, including, for example, spectrum modulation techniques such as Orthogonal Frequency Division Multiplex (OFDM) and Direct Sequence Spread Spectrum (DSSS). Use of other modulation techniques is also contemplated.

The coupling circuits 441-444 may be configured for coupling the PLC device 400 to the power line. The purpose of the coupling circuits 441-444 may include preventing the high-power signal (e.g., 60 Hz in US) to enter into and possibly damage the PLC device 400 and further for ensuring that communication to and from the PLC device 400 occurs within the dynamically-selected communication frequency band. Therefore, the coupling circuits 441-444 may be configured to provide a desired galvanic isolation of the PLC device 400 from the power line. Likewise, the coupling circuits 441-444 may include capacitive coupling, inductive coupling, adaptable notch-filter networks, or any combination thereof.

In operation, the PLC device 400 may be configured for dynamically selecting both the frequency band and carrier frequencies responsive to an on-line assessment of the given PLC network. For example, the cutoff frequency estimator 420 may be configured for estimating a cutoff frequency for communication on the given PLC network and the processor 410 may be configured for dynamically selecting a communication scheme responsive to the estimated cutoff frequency.

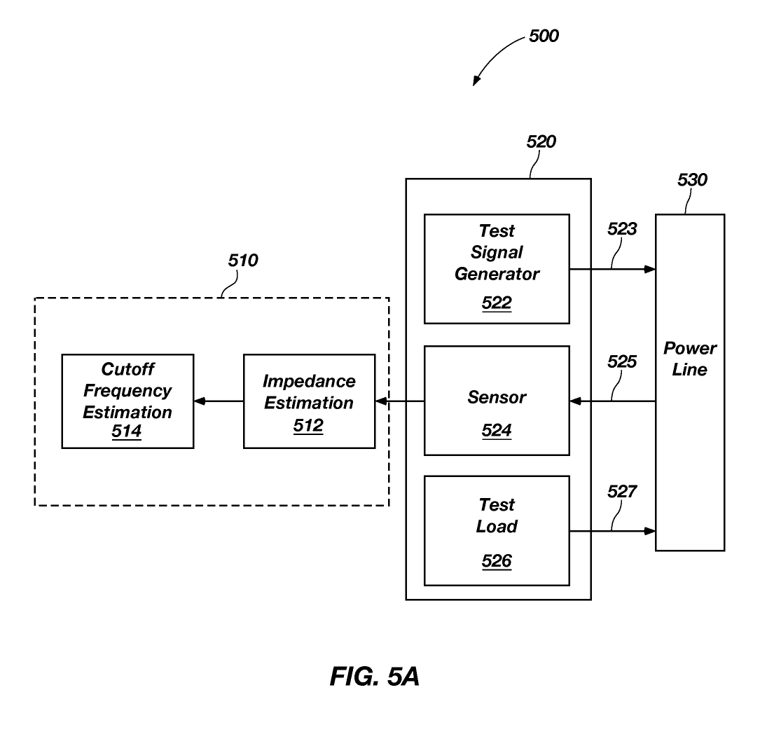

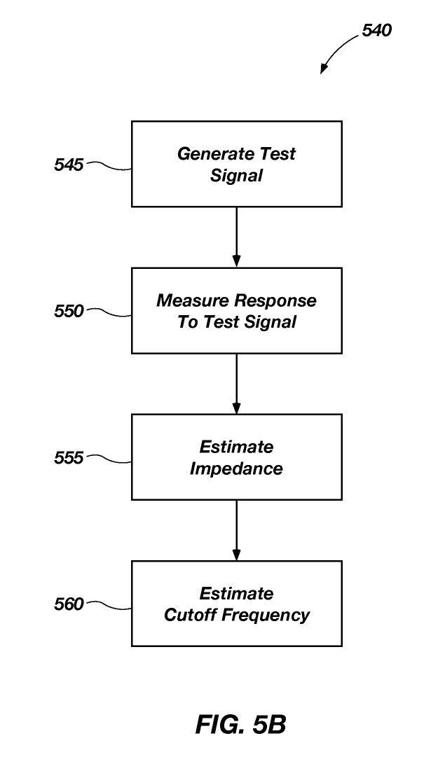

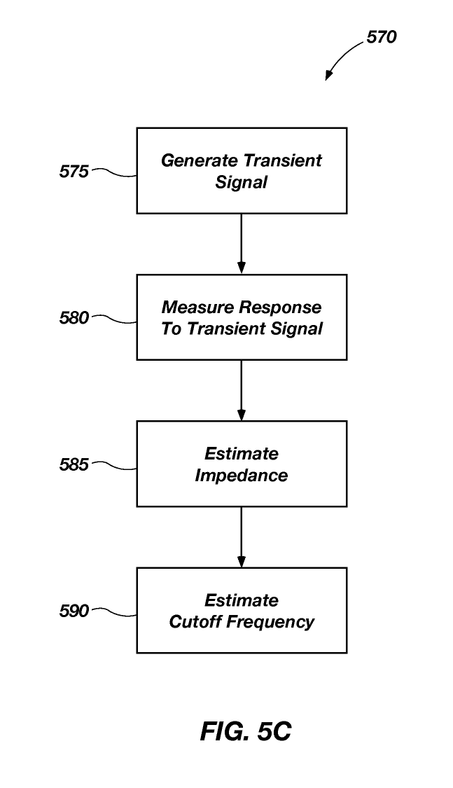

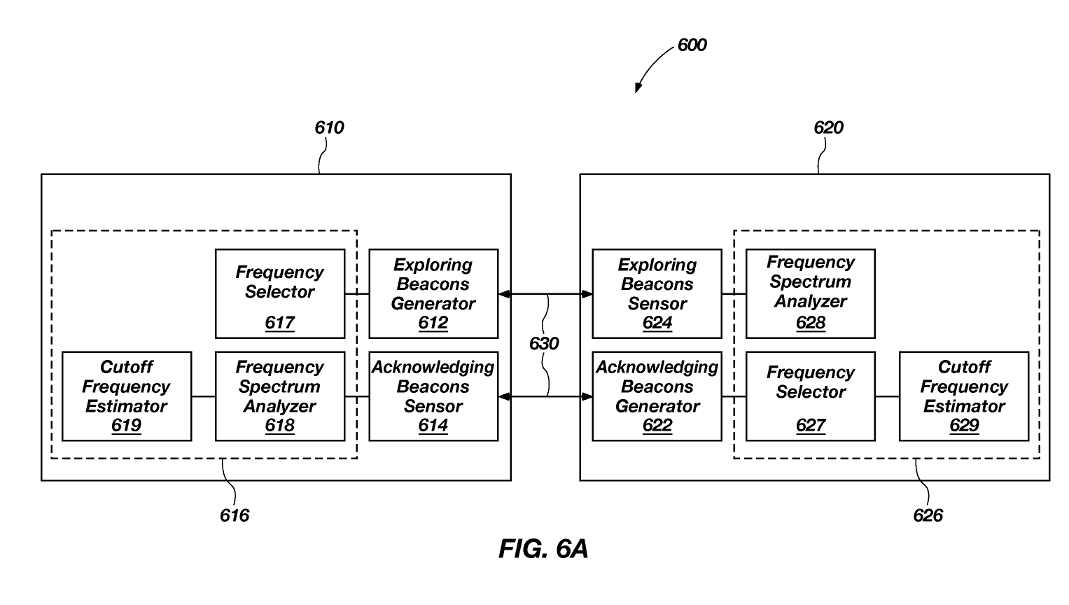

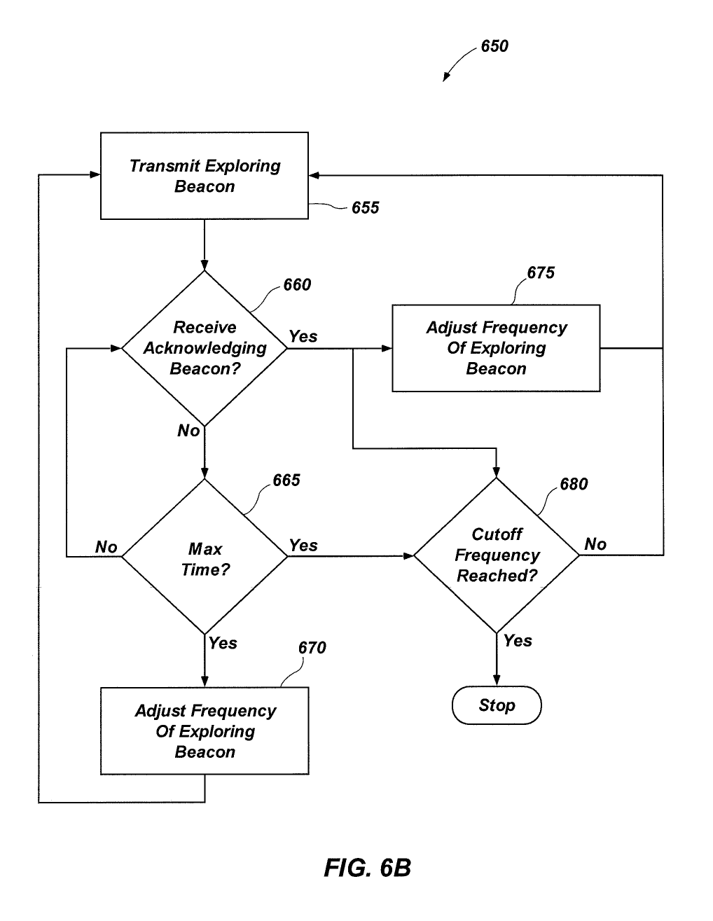

In particular, the cutoff frequency estimator 420 may be configured to estimate the cutoff frequency of the PLC network, which estimation may be performed by one or more methods. For example, one method for estimating the cutoff frequency of the PLC network may include determining the impedance of the given power line. Another method for estimating the cutoff frequency of the PLC network may include transmitting exploring beacon signals. Examples of methods for estimating the cutoff frequency of the PLC network will be discussed with respect to FIGS. 5A-5C and 6A-6B.

With an estimation of the cutoff frequency, the processor 410 may be configured to ensure that the upper boundary of the frequency band is at or below the estimated cutoff frequency. In some embodiments, the upper boundary of the frequency band may be approximately equal to the estimated cutoff frequency. The lower boundary of the frequency band may be based, at least in part, on maintaining frequencies to achieve a desired throughput, or based, at least in part, on having a range of carrier frequencies to ensure a desired probability for reliable carriers below the cutoff frequency (f_{c}), or both. The frequency for the lower boundary may also be based on other factors.

For example, FIG. 4B is a flow chart 450 illustrating a method for communicating over a PLC network with a PLC device including dynamically adjusting an adaptable frequency band according to an embodiment of the present invention. At operation 460, the cutoff frequency of the PLC network may be estimated. Further details regarding methods for estimating the cutoff frequency will be provided below. At operation 470, the boundaries of the adaptive frequency band for communication over the PLC network may be dynamically adjusted in response to the estimated cutoff frequency. For example, the upper boundary of the adaptive frequency band may be ensured to be approximately at or below the estimated cutoff frequency of the PLC network. At operation 480, with the adaptive frequency band selected responsive to the cutoff frequency of the PLC network, communication signals may be transmitted and received over the PLC network at carrier frequencies within the adaptive frequency band. As the adaptive frequency band may be dynamically adjusted, the method illustrated in flow chart 450 may be repeated in order to detect and react to changes to the characteristics of the PLC network.

FIG. 5A is a schematic block diagram of a PLC device 500 according to an embodiment of the present invention. PLC device 500 includes a processor 510 and one or more modules 520 coupled to a power line 530 of a PLC network, which modules may be configured to generate and receive signals used in estimating the cutoff frequency of the power line 530. The one or more modules 520 may include a test signal generator 522, a sensor 524, a test load 526, or combinations thereof. The processor 510 may be configured to perform functions for impedance estimation 512 and cutoff frequency determination 514. Processor 510 may include one or more processors for performing functions described herein. Although not shown in FIG. 5A, PLC device 500 may include a transmitter and receiver for transmitting and receiving data with desired carrier signals with carrier frequencies within the adaptive frequency band. Such a transmitter and receiver may be configured similarly to those described with reference to FIG. 4A.

The PLC device 500 may be configured to adjust the boundaries of the adaptive frequency band responsive to an estimation of the cutoff frequency of the PLC network. For example, the PLC device 500 may estimate the impedance of the PLC network, which impedance may be used to estimate the cutoff frequency for the PLC network. Calculating the estimated impedance of the PLC network may be accomplished by one or more methods. One method may employ the test signal generator 522 and the sensor 524. Another method may employ the test load 526 and the sensor 524. Examples of these two methods will be described below. Use of other methods for calculating an estimated impedance of the PLC network is also contemplated.

In one method of estimating the impedance of the PLC network, the test signal generator 522 transmits a test signal 523 with a predetermined frequency into the power line 530. The test signal 523 may be a sinusoidal current with a predetermined frequency at a power and magnitude that are sufficiently below the power and magnitude of the current being carried by the power line 530. The test signal 523 may cause a corresponding voltage signal (i.e., response) on the power line 530. The sensor 524 may be configured to measure the response 525 from the power line 530. In other words, the processor 510 may be configured to perform an impedance estimation 512 according to the characteristics of the power line 530 measured before the test signal 523 and after the test signal 523 was transmitted. The processor 510 may estimate the magnitude and phase angle of the impedance of the power line 530 at the frequency of the test signal 523 from the measured magnitude and phase of the resulting response 525 from the power line 530).

The test signal generator 522 may transmit a plurality of test signals 523 into the power line 530 at different frequencies. As a result, the processor 510 may perform an impedance estimation 512 for the PLC network based, at least in part, on the response 525 of the power line 530 for a plurality of test signals 523 at a plurality of discrete frequencies. In other words, the response 525 may be used to estimate the impedance of the PLC network. Thus, the plurality of test signals 523 and corresponding measured response 525 may be repeated for frequency carriers within a frequency band of interest to determine a cutoff frequency determination and generate a frequency characteristic for the frequency range of interest as compared to the wideband impedance of the power line 530. As a result, the impedance of the power line 530 may not necessarily be fully characterized for all frequencies, but may rather be characterized for a reduced number of frequencies sufficient for estimating the cutoff frequency. For example, if the processor 510 determines that an estimated impedance of the power line 530 at a given frequency is overly large and unfavorable for reliable communication, the processor 510 may determine that it may not be necessary to continue measurements for frequencies higher than that given frequency. With an estimated impedance for the power line 530 for one or more frequencies, the processor 510 may perform a cutoff frequency estimation 514 based, at least in part, on the estimated impedance.

In another method for estimating the impedance of the PLC network, the test load 526 may be temporarily coupled (i.e., switched) via an energized connector to the power line 530. Temporarily coupling a test load 526 may cause a perturbation (i.e., current and transient signals 527) to the power line 530, the response 525 of which transient signal 527 is measured by the sensor 524. The test load 526 may include a plurality of known test loads (e.g., capacitors) coupled with the power line 530. The test load 526 may be selected in a manner such as to generate transient signals 527 below the magnitude of the current being carried by the power line 530. The processor 510 may be configured to analyze the response 525 of the power line 530 for impedance estimation 512 that is also used for cutoff frequency estimation 514. For example, the processor 510 may estimate the impedance of the power line 530 based, at least in part, on the characteristics (e.g., phase, magnitude, and frequency) of the response 525 generated from connecting the test load 526 to the power line 530. Hysteresis in the PLC network may be reduced by timing of the coupling of test load 526 to the power line 530 to be performed at the zero crossing of the amplitude for the main voltage waveform of the power line 530. The sections of the test load 526 may also be sequentially switched for generating the transient signals 527.

As each method may not include each component shown in FIG. 5A, one or more components may not be included in every embodiment. For example, one method has been described that employs test signal generator 522 and sensor 524 for generating a transmitted test signal 523, the response 525 to which can be measured to estimate impedance and cutoff frequency. Therefore, the one or more modules 520 may not necessarily include test load 526. Another method has been described that employs temporarily switching a test load 526 to couple with the power line 530 in order to generate transient signals 527, the response 525 to which can be measured by the sensor 524 to estimate impedance and cutoff frequency. Therefore, the one or more modules 520 may not necessarily include test signal generator 522. Other methods may include a combination of employing a test signal generator 522 and a test load 526, or by employing other methods for estimating an impedance and cutoff frequency of the power line 530.

FIGS. 5B and 5C are flow diagrams 540, 570 illustrating methods for estimating the impedance of a PLC network used to estimate a cutoff frequency for communication over a PLC network according to an embodiment of the present invention. Referring specifically to FIG. 5B, at operation 545 a test signal is generated and transmitted into a PLC network generating a response thereto. The test signal may exhibit a predetermined frequency. The test signal may include a plurality of test signals being transmitted into the PLC network, the plurality of test signals having a plurality of discrete frequencies within a frequency band of interest. At operation 550, the response to the test signal from the PLC network may be measured. At operation 555, the impedance of the PLC network may be estimated. The measured response to the test signal may be used to estimate the impedance of the PLC network. At operation 560, the cutoff frequency for the PLC network may be estimated. The estimated impedance of the PLC network may be used to estimate the cutoff frequency for the PLC network. In response to the estimation of the cutoff frequency, the boundaries for an adaptive frequency band for communication over the PLC network may be set as previously described herein.

Referring specifically to FIG. 5C, at operation 575 a transient signal is generated and transmitted into a PLC network generating a response thereto. The transient signal may be generated and transmitted into the PLC network by temporarily coupling a test load to the power line of the PLC network. Temporarily coupling the test load to the power line may include charging and discharging at least one capacitor coupled to the power line. At operation 580, the response to the transient signal from the PLC network may be measured (e.g., the response to the coupling of the test load to the power line of the PLC network). At operation 585, the impedance of the PLC network may be estimated based, at least in part, on the measured response to the transient signal (e.g., test load connection to the power line). At operation 590, the cutoff frequency for the PLC network may be estimated based, at least in part, on the estimated impedance of the PLC network. In response to the estimation of the cutoff frequency, the boundaries for an adaptive frequency band for communication over the PLC network may be set as previously described herein.

FIG. 6A is a schematic block diagram of a PLC network 600 according to an embodiment of the present invention. PLC network 600 may include a plurality of PLC devices 610, 620 configured for determining the cutoff frequency of a power line 630 by transmitting sinusoidal signals with a predetermined frequency into the power line 630. As the purpose of transmitting these sinusoidal signals is to explore whether the sinusoidal signals can travel within the given PLC network 600 and find a corresponding PLC device (e.g., 610, 620) connected to the power line 630, the transmitted sinusoidal signals may be called beacons. The PLC device 610 configured for querying the PLC network by generating and transmitting exploring beacons may be called a questioner 610, while the PLC device 620 configured for responding to the reception of the exploring beacons may be called a responder 620.

The questioner 610 may include an exploring beacons generator 612 and an acknowledging beacons sensor 614. The exploring beacons generator 612 may be configured to transmit exploring beacons into the power line 630 at a power and magnitude sufficiently below the power and magnitude of the current being carried by the power line 630, but also at a power and magnitude sufficiently above the noise level present at the frequency of the exploring beacon. The questioner 610 may further include a processor 616 configured to perform functions of a frequency selector 617, a frequency spectrum analyzer 618, and a cutoff frequency estimator 619. As previously discussed, a processor 616 may include one or more processors for performing functions described herein.

The exploring beacons generator 612 and acknowledging beacons sensor 614 may be coupled to the processor 616 and the power line 630. The exploring beacons generator 612 and acknowledging beacons sensor 614 may be coupled to the power line 630 by an isolating circuit (not shown). The isolating circuit may further be configured for blocking frequencies at and around the frequency (e.g., 60 Hz in USA) for power transmission on the power line 630.

The responder 620 may include an acknowledging beacons generator 622 and an exploring beacons sensor 624. The exploring beacons sensor 624 may be configured to receive exploring beacons from a questioner 610. The acknowledging beacons generator 622 may be configured to transmit acknowledging beacons into the power line 630 in response to reception of the exploring beacons. The acknowledging beacons may be transmitted at a power and magnitude sufficiently below the power and magnitude of the current being carried by the power line 630, but also at a power and magnitude sufficiently above the noise level present at the frequency of the acknowledging beacon. The responder 620 may further include a processor 626 configured to perform functions of a frequency selector 627, frequency spectrum analyzer 628, and cutoff frequency estimator 629.

The acknowledging beacons generator 622 and exploring beacons sensor 624 may be coupled to the processor 626 and the power line 630. The acknowledging beacons generator 622 and exploring beacons sensor 624 may be coupled to the power line 630 by an isolating circuit (not shown). The isolating circuit may further be configured for blocking frequencies at and around the frequency (e.g., 60 Hz in USA) for power transmission on the power line 630.

The frequency spectrum analyzers 618, 628 for both the questioner 610 and the responder 620 are configured to analyze the frequencies of the signals detected by the sensors 614, 624. By analyzing the frequencies of the signals, the processors 610, 620 may determine whether the signals detected by the sensors 614, 624 are the expected frequencies for the appropriate exploring and acknowledging beacons.

In operation, the exploring beacons generator 612 of the questioner 610 may generate and transmit exploring beacons over power line 630. The responder 620 may continually monitor the frequency spectrum of the signals on the power line 630 in order to detect the presence of exploring beacons. If a responder 620 detects exploring beacons, the responder 620 may acknowledge receiving the exploring beacons by transmitting acknowledging beacons into the power line 630.

As for the responder 620, if the frequency spectrum analyzer 628 confirms receipt of an exploring beacon, the frequency selector 627 determines the frequency for the acknowledging beacons to be transmitted. On the questioner 610 end, the frequency selector 617 determines the frequency for the exploring beacons depending on the reception or non-reception of the acknowledging beacons. The cycle of transmitting and receiving exploring beacons and acknowledging beacons at different frequencies may continue until a cutoff frequency estimator 619, 629 determines that the estimated cutoff frequency is reached. The cutoff frequency estimator 619, 629 may report the cutoff frequency of the PLC network to a PLC device, or to other PLC devices coupled with the PLC network.

The exploring beacons may be transmitted in pairs by a given questioner 610. Likewise, the acknowledging beacons may be transmitted in pairs by a given responder 620. For example, a first exploring beacon may be transmitted at 10 kHz followed by a second exploring beacon transmitted at 11 kHz. If the responder 620 receives the sequence of exploring beacons at 10 kHz and 11 kHz, the responder 620 may generate a sequence of acknowledging beacons. The frequencies of the acknowledging beacons may be different from the frequencies of the exploring beacons. For example, the responder 620 may transmit a first acknowledging beacon at 8 kHz and a second acknowledging beacon at 9 kHz. If the questioner 610 receives the sequence of the acknowledging beacons at 8 kHz and 9 kHz, the questioner 610 may determine that the proper acknowledging beacons are received. Transmitting a plurality of exploring beacons and acknowledging beacons for a given sequence may increase the confidence that the responder 620 and the questioner 610 detected the appropriate signals rather than merely noise signals. Transmitting a greater number of exploring beacons and acknowledging beacons for a given sequence may also be contemplated, which may further increase the confidence in the results of the cutoff frequency estimation.

After the transmission of the exploring beacons, if the questioner 610 does not receive acknowledging beacons from a responder 620 within a predetermined time period, the questioner 610 may conclude that the frequencies of the exploring beacons are higher than the cutoff frequency of the power line 630. If the exploring beacons are determined to exhibit a higher frequency than the cutoff frequency, then the frequency of the exploring beacons may be reduced, and additional exploring beacons may be transmitted. If the questioner 610 receives the corresponding acknowledging beacons, the questioner 610 may conclude that the frequencies of the exploring beacons are lower than the cutoff frequency of the power line 630, whereupon the questioner may increase the frequency of the exploring beacons, and additional exploring beacons may be transmitted. The process of transmitting exploring beacons and waiting for acknowledging beacons may be repeated over a range of frequencies in order to determine the cutoff frequency.

The processor 616 may determine a frequency for the frequency selector 617 to convey to the exploring beacons generator 612 to transmit the next exploring beacon. For example, the frequencies for the exploring beacons may start at a predetermined maximum frequency and decrease incrementally until a transition is reached in which an acknowledging beacon is received by the acknowledging beacons sensor 614. Another example may incrementally increase the frequencies for the exploring beacons from a predetermined minimum frequency until a transition in which an acknowledgment beacon is not received by the acknowledging beacons sensor 614. It may not be desirable for every frequency to be tested by transmitting an exploring beacon at every frequency. The frequency spectrum analyzer 618 function may be configured to skip certain frequency carriers (e.g., through an optimization scheme) and converge at an estimated cutoff frequency. In other words, each frequency carrier may not necessarily be fully queried, but may instead be optimally selected such that the number of frequency carriers employed for exploratory beacons is reduced for converging to an estimating cutoff communication frequency. In addition, the time required for converging at a cutoff frequency with exploring beacons may be further reduced by limiting the frequency band to a predefined search frequency band.

It shall be noted that estimating a cutoff frequency for a PLC network of interest using a beacon-based method may employ at least two PLC devices (e.g., one configured as a questioner and one configured as a responder) within the PLC network. If, in a beacon-based method, the frequency spectrum analyzer 618 function cannot determine whether a cutoff frequency is within a predefined search frequency band, such a result may be ambiguous. For example, if no cutoff frequency is determined, the true cutoff frequency may simply be below the lowest frequency limit of the predefined search frequency band. Alternatively, the true cutoff frequency may simply be above the highest frequency limit of the predefined search frequency band. Alternatively, there may just not be another PLC device connected to the PLC network being analyzed, such that acknowledging beacons may not be able to be generated.

It shall further be noted that a PLC device connected to the power line 630 may operate as both a questioner or a responder, as the case may be. Thus, each of the PLC devices 610, 620, may include each of the components mentioned above, including an exploring beacons generator 612, an acknowledging beacons sensor 614, an exploring beacons sensor 624, an acknowledging beacons sensor 622, and a processor 616, 626 with functions as described herein.

As each PLC device in a PLC network may be configured to operate as a questioner 610 and a responder 620, a protocol may be provided within the PLC network to ensure that after an initiation period, only one PLC device in the PLC network behaves as a questioner 610, while the remaining PLC devices in the PLC network behave as responders 620 throughout the process of discovering the cutoff frequency of the PLC network. The PLC devices configured as questioners 610 may further include control logic that directs a questioner 610 to first determine whether there already exist exploring beacons in the PLC network prior to starting transmission of exploring beacons. If exploring beacons presently exist in the PLC network, the questioner 610 portion of the particular PLC device may be disabled, and the PLC device may operate only as a responder 620 throughout the cutoff frequency estimation process. Once a cutoff frequency is estimated by a questioner 610 in the PLC network, the cutoff frequency may be communicated to other PLC devices in the PLC network.

FIG. 6B is a flow chart 650 illustrating a method for determining a cutoff frequency according to an embodiment of the present invention. At operation 655, an exploring beacon is transmitted into the PLC network. The exploring beacon may be a first exploring beacon with a first frequency within the frequency band of interest. At operation 660, a PLC device waits to receive an acknowledging beacon from another PLC device coupled with the PLC network. If an acknowledging beacon is not received, the PLC device waits until a maximum time for waiting has expired at operation 665. If the maximum time expires at operation 665, the frequency for a second (i.e., subsequent) exploring beacon may be adjusted at operation 670, and a subsequent exploring beacon is transmitted with the adjusted frequency at operation 655. If an acknowledging beacon is received at operation 660, the frequency for a second (i.e., subsequent) exploring beacon may be adjusted at operation 675, and a subsequent exploring beacon is transmitted with the adjusted frequency at operation 655. As a result, transmitting a subsequent exploring beacon with a subsequent frequency into the PLC network may result from the subsequent frequency being either increased or decreased from a previous frequency of a previous exploring beacon responsive to either reception or non-reception of an acknowledging beacon from the PLC network, as the case may be.

Whether the adjustment of frequency of subsequent exploring beacons is increased or decreased at operations 670 and 675 may depend on the starting frequency and configuration for converging at an estimated cutoff frequency. For example, the first exploring beacon may start with a predetermined maximum frequency, and estimating the cutoff frequency may include transmitting additional exploring beacons at frequencies below the predetermined maximum frequency until the reception status of the acknowledging beacons transitions from “not being received” to “being received” by the PLC device. Alternatively, the first exploring beacon may start with a predetermined minimum frequency, and estimating the cutoff frequency may further include transmitting additional exploring beacons at frequencies above the predetermined minimum frequency until the reception status of the acknowledging beacons transitions from “being received” to “not being received” by the PLC device. Estimating the cutoff frequency may further include subsequently transmitting additional exploring beacons according to an algorithm that generates frequencies for the additional exploring beacons until converging at a transition status within a desired error level for estimating the cutoff frequency.

As a result, at operation 680, a determination may be made as to whether the estimated cutoff frequency has been reached. Such a determination may be responsive to detecting a transition where the receiving status of the acknowledging beacons transitions between the status of “being received” by the PLC device, to “not being received” by the PLC device, or according to another algorithm to determine convergence of the frequencies for the exploring beacons. Such an algorithm may both increase and decrease frequencies, and skip frequencies for subsequent exploring beacons signals in order to converge to the cutoff frequency in a relatively faster period of time. In response to the estimation of the cutoff frequency, the boundaries for an adaptive frequency band for communication over the PLC network may be set as previously described herein.

While the invention is susceptible to various modifications and implementation in alternative forms, specific embodiments have been shown by way of non-limiting example in the drawings and have been described in detail herein. It should be understood that the invention is not intended to be limited to the particular forms disclosed. Rather, the invention includes all modifications, equivalents, and alternatives falling within the scope of the following appended claims and their legal equivalents.

1. A power line communication device, comprising:
a cutoff frequency estimator configured for estimating a cutoff frequency for communication in a power line communication network; and
a processor operably coupled with the cutoff frequency estimator, wherein the processor is configured to adaptively select at least a boundary of a frequency band in response to the estimated cutoff frequency.

2. The power line communication device of claim 1, wherein the cutoff frequency estimator is further configured for estimating an impedance of the power line communication network, and wherein the cutoff frequency is estimated based, at least in part, on the impedance of the power line communication network.

3. The power line communication device of claim 2, wherein the cutoff frequency estimator comprises:
a test signal generator configured for transmitting a test signal into a power line in the power line communication network; and
a sensor operably coupled to the power line, wherein the sensor is configured to measure a response for the power line communication network in response to the test signal, wherein the impedance is estimated based, at least in part, on the response measured by the sensor.

4. The power line communication device of claim 2, wherein the cutoff frequency estimator comprises:
a test load configured for generating a transient signal into the power line in the power line communication network; and
a sensor operably coupled to the power line, wherein the sensor is configured to measure a response for the power line communication network in response to the transient signal, wherein the impedance is estimated based, at least in part, on the response measured by the sensor.

5. The power line communication device of claim 4, wherein the test load comprises at least one capacitor, wherein the transient signal is generated by charging and discharging the at least one capacitor.

6. The power line communication device of claim 1, wherein the cutoff frequency estimator comprises:
an exploring beacons generator configured for generating an exploring beacon to be transmitted to another power line communication device in the power line communication network; and
an acknowledging beacons sensor configured for receiving an acknowledging beacon from the another power line communication device in the power line communication network.

7. The power line communication device of claim 6, wherein the cutoff frequency estimator further comprises a frequency selector configured to change a frequency of the exploring beacon responsive to at least one of reception and non-reception of the acknowledging beacon.

8. The power line communication device of claim 6, wherein the cutoff frequency estimator further comprises:
an exploring beacons sensor configured for receiving an incoming exploring beacon from the another power line communication device in the power line communication network; and
an acknowledging beacons generator configured for generating an outgoing acknowledging beacon into the power line communication network in response to receiving the incoming exploring beacon from the another power line communication device in the power line communication network.

9. The power line communication device of claim 1, wherein an upper boundary of the frequency band is adaptively selected to be approximately the estimated cutoff frequency.

10. A power line communication device, comprising:
a transmitter configured for transmitting communication signals on a power line communication network at frequencies within an adaptive frequency band;
a receiver configured for receiving communication signals from the power line communication network at frequencies within the adaptive frequency band; and
a processor operably coupled with the transmitter and the receiver, wherein the processor is configured to dynamically select an upper boundary of the adaptive frequency band independently from a lower boundary of the adaptive frequency band.

11. The power line communication device of claim 10, further comprising a cutoff frequency estimator operably coupled with the processor, wherein the cutoff frequency estimator is configured for estimating a cutoff frequency for communication in a power line communication network responsive to an on-line assessment of the power line communication network.

12. The power line communication device of claim 11, wherein the upper boundary of the adaptive frequency band is approximately equal to the cutoff frequency.

13. The power line communication device of claim 11, wherein the upper boundary of the adaptive frequency band is ensured to be below the cutoff frequency.

14. The power line communication device of claim 13, wherein the lower boundary of the adaptive frequency band is selected to have a range of carrier frequencies between the upper boundary and the lower boundary in order to achieve desired probability for having reliable carrier signals for communicating over the power line communication network.

15. The power line communication device of claim 11, wherein the lower boundary of the adaptive frequency band is selected to have a range of frequencies in order to achieve a desired throughput for communicating over the power line communication network.

16. A method for dynamically adjusting a frequency band for communicating over a power line communication network, the method comprising:
estimating a cutoff frequency for a power line communication network; and
adjusting an upper boundary of an adaptive frequency band for communicating over the power line communication network responsive to estimating the cutoff frequency.

17. The method of claim 16, wherein estimating the cutoff frequency comprises:
estimating an impedance of the power line communication network; and
estimating the cutoff frequency based, at least in part, on the impedance estimated for the power line communication network.

18. The method of claim 17, wherein estimating an impedance of the power line communication network comprises:
transmitting a test signal into the power line communication network;
measuring a response to the test signal from the power line communication network; and
calculating the impedance of the power line communication network based, at least in part, on the measured response to the test signal.

19. The method of claim 18, wherein transmitting a test signal into the power line communication network comprises generating a test signal with a predetermined frequency.

20. The method of claim 18, wherein transmitting a test signal into the power line communication network comprises generating a transient signal by temporarily coupling a test load to a power line in the power line communication network.

21. The method of claim 20, wherein temporarily coupling a test load to the power line includes charging and discharging at least one capacitor coupled to the power line in the power line communication network.

22. The method of claim 18, wherein estimating an impedance of the power line communication network comprises:
transmitting a plurality of test signals into the power line communication network, the plurality of test signals having a plurality of discrete frequencies within a frequency band of interest;
measuring a response to the plurality of test signals from the power line communication network; and
calculating the impedance of the power line communication network based, at least in part, on the measured response to the plurality of test signals over the plurality of discrete frequencies.

23. The method of claim 16, wherein estimating the cutoff frequency comprises:
transmitting a first exploring beacon with a first frequency into the power line communication network;
transmitting a second exploring beacon with a second frequency into the power line communication network, the second frequency being one of increased and decreased from the first frequency responsive to one of reception and non-reception of acknowledging beacons from the power line communication network associated with the first exploring beacon; and
determining a cutoff frequency at a transition where receiving the acknowledging beacons transitions between being received to not being received.

24. The method of claim 23, wherein transmitting a first exploring beacon includes transmitting a plurality of exploring beacons with different frequencies.

25. The method of claim 23, wherein transmitting a first exploring beacon is at a predetermined maximum frequency, and estimating the cutoff frequency further comprises subsequently transmitting additional exploring beacons at frequencies below a maximum frequency until the transition is reached where receiving the acknowledging beacons transitions from not being received to being received.

26. The method of claim 23, wherein transmitting a first exploring beacon is at a predetermined minimum frequency, and estimating the cutoff frequency further comprises subsequently transmitting additional exploring beacons at frequencies above the minimum frequency until the transition is reached where receiving the acknowledging beacons transitions from being received to not being received.

27. The method of claim 23, wherein estimating the cutoff frequency further comprises subsequently transmitting additional exploring beacons according to an algorithm that generates frequencies for the additional exploring beacons until converging at a transition within a desired error level for estimating the cutoff frequency.
